(19) United States
(12) Patent Application Publication
(10) Pub. No.: US 2007/0022151 A1
(43) Pub. Date: Jan. 25, 2007

(54) Dynamic management of a keyboard memory

(76) Inventors: Juergen Lieb, Gochsheim (DE); Bernd Grossmann, Bad Neustadt a.d. Saale (DE); Rudolf Limpert, Salz (DE)

Correspondence Address: MCGRATH, GEISSLER, OLDS & RICHARDSON, PLLC, P.O. BOX 1364, FAIRFAX, VA, 22038-1364, US

(21) Appl. No.: 11/518,445

(22) Filed: Sep. 11, 2006

Related U.S. Application Data
(63) Continuation of application No. PCT/EP05/02645, filed on Mar. 11, 2005.

(30) Foreign Application Priority Data
Mar. 11, 2004 (DE) DE102004012338.1

(51) Int. Cl. G06F 3/00

(52) U.S. Cl. 708/145

(57) ABSTRACT

A method is disclosed for entering and/or changing the data assigned to keys and/or accessory devices of a freely programmable keyboard and stored in at least one programmable memory, a method for retrieving these data, and to a keyboard for carrying out the method. So that despite limited available memory space in the freely programmable memory, the particular keyboard can be optimally adapted to user requirements, the invention proposes dynamic management of the programmable memory of the keyboard, i.e., only as much memory space is used per key as is actually necessary for this. The unneeded memory space is therefore available to the other keys.

This nonprovisional application is a continuation of International Application PCT/EP2005/002645, which was filed on Mar. 11, 2005, and which claims priority to German Patent Application No. DE 102004012338, which was filed in Germany on Mar. 11, 2004, and which are both herein incorporated by reference.

### BACKGROUND OF THE INVENTION

1. Field of the Invention

The present invention relates to a method for the retrieval of data assigned to keys and/or accessory devices of a freely programmable keyboard and stored in at least one programmable memory, a method for entering and/or changing these data, and a keyboard for carrying out the method.

2. Description of the Background Art

Freely programmable keyboards are known, particularly point of sale keyboards for Points of Sale (POS), which comprise, in addition to a keyboard block, a microprocessor, which detects the activated keys or key combinations and assigns characters or functions to these. In this regard, the microprocessor is connected to at least one programmable memory, which contains the corresponding data (characterizing the characters or functions). In the known keyboards, a specific, permanently preset memory area of the programmable memory is reserved in each case per key code, and thereby per key or key combination.

If the assignment between the pressed key or key combination and the corresponding meaning (i.e., memory content) is to be changed, either the memory is reprogrammed, for example, by an external PC or the entire memory can be replaced by a new, suitably preprogrammed memory.

It has proven disadvantageous in practice, however, that the maximum memory space per key code is permanently preset. If this memory space is needed only partially for the data, the remaining free memory space cannot be used for another key code (or programming levels).

In addition, memory space must be reserved for available programming levels, also when no programming occurs in the relevant level. Finally, the number of possible programming levels is fixed.

### SUMMARY OF THE INVENTION

It is therefore an object of the present invention to provide a method with which despite limited available memory space in the freely programmable memory, the specific keyboard can be optimally adapted to user requirements, namely, also when the result with new programming for the keyboard is that more memory space is necessary for a key or key combination than originally assumed.

The invention is based substantially on the idea of managing the programmable memory of the keyboard not statically as before, but dynamically; i.e., only as much memory space is used per key as is actually necessary for the corresponding assigned information. The unneeded memory space, in contrast, is available to the other keys and/or freely programmable accessory devices. This occurs in that during retrieval of data assigned to the keys and/or accessory devices of a freely programmable keyboard and stored in at least one programmable memory, by memory addresses stored in a first area of the programmable memory, the memory locations containing the data are addressed in a second area of the programmable memory.

The advantage of this dynamic memory management therefore is that the available memory space of the programmable memory is optimally utilized.

Another advantage of the invention is that the number of programming levels per key can be 128. The memory can be managed dynamically in this case as well.

To this end, the entry and/or change of the data assigned to the keys and/or accessory devices of a freely programmable keyboard and stored in at least one programmable memory occurs by setting or changing the occupation of the programmable memory in an external device and transferring this to the keyboard via an interface. In so doing, only so much memory space is used per key and/or accessory device as is absolutely necessary for the data to be stored in that the individual memory areas occupied by data are directly adjacent to one another. A PC or a special programming device is used advantageously as the external device.

A programmable keyboard according to the invention comprises a keyboard block, a microprocessor, at least one programmable memory with the keys and/or accessory devices of the data assigned to the freely programmable keyboard, a program memory, and an interface, whereby the occupation of the memory can be transmitted to the keyboard via the interface. In an advantageous manner, the programmable memory and/or the program memory is (are) integrated into the microprocessor.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block diagram of a keyboard device according to an embodiment of the present invention;

FIG. 2 is a schematic drawing to illustrate the static memory management;

FIG. 3 is an enlarged detail of the view shown in FIG. 2;

FIG. 4 is a schematic drawing to illustrate the dynamic memory management; and

FIG. 5 is an enlarged detail of the view shown in FIG. 4.

### DETAILED DESCRIPTION

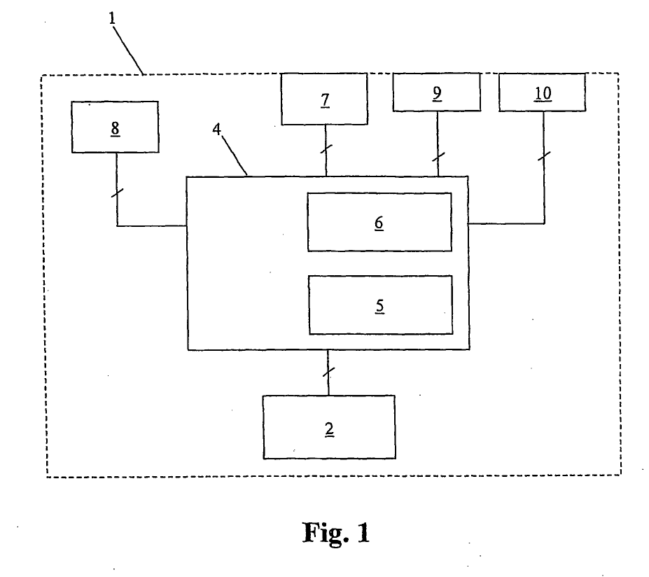

In FIG. 1, the number 1 designates a freely programmable keyboard device (e.g., a point of sale keyboard), which includes a keyboard block 2, a microprocessor 4, a program memory 5, and a programmable data memory 6.

The program memory 5 contains the program code, which is executed during operation of keyboard 1 by the microprocessor. The data assigned to the keys and/or accessory devices are stored in programmable memory 6. In the present example, both program memory 5 and programmable memory 6 are integrated into microprocessor 4.

Microprocessor 4 is connected to a keyboard interface 7 and a magnetic card reader 8. The keyboard interface is designed depending on the field of application as a PS/2, USB, or RS232 interface. In addition, for connection with other additional devices, microprocessor 4 is connected to several interfaces 9, 10 of keyboard 1 via a BUS system.

Microprocessor 4 regularly polls the status of the keyboard block 2 and determines in a manner known which key or key combination was pressed. Next, the assignment of a character, a character string, or a command to the pressed key or key combination occurs based on the data stored in programmable memory 6.

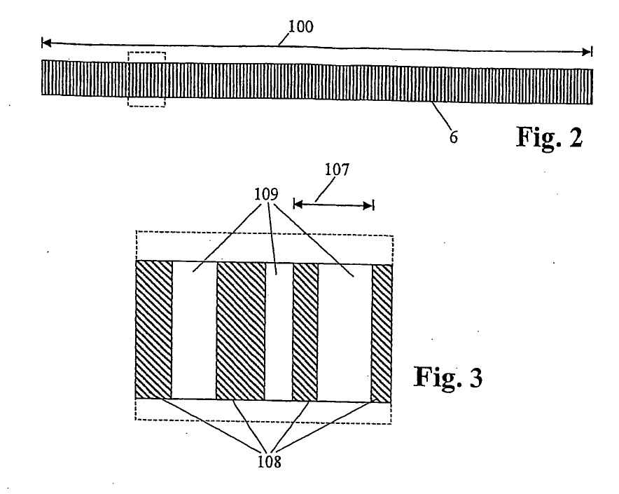

FIGS. 2 and 3 show the static memory allocation known from the conventional art. Here, programmable memory 6 is shown schematically as a rectangle, whose length corresponds to the entire available memory area 100. In this case, the entire memory area 100 has a plurality of memory cells 107 of the same width, each memory cell 107 being assigned a key or key combination or an accessory device. The size of specific memory cells 107 is determined by the maximum size of the information to be stored in a cell, which must be preset beforehand and cannot be changed afterwards. As a rule, this means that only part of specific memory cell 107 is occupied by information (in FIG. 3, this is indicated by the hatched memory areas 108). The remaining memory area 109 of specific memory cell 107, in contrast, is not occupied by data and is available for storing the information of other keys. The addressing of memory cells emerges from an equidistant occupation of memory 6. The position to be addressed in memory 6 is calculated from the pressed key or key combination.

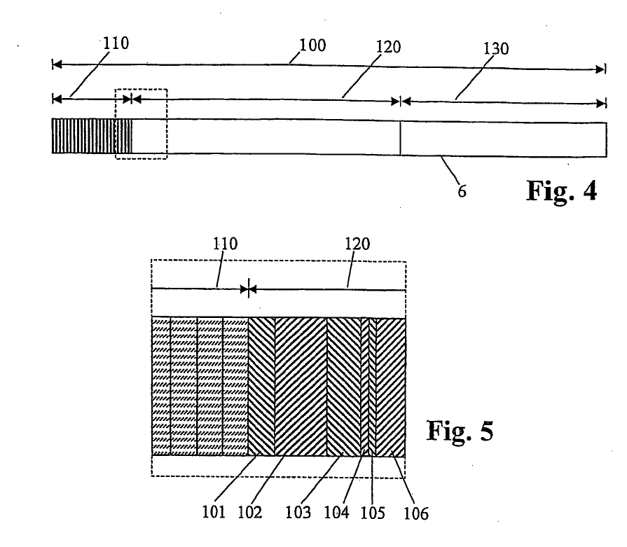

The dynamic utilization of memory 6 according to the invention is illustrated in FIGS. 4 and 5. Here, memory 6 has three areas: Area 110 contains a memory allocation table, area 120 the information assigned to the keys, and area 130 is empty. If a key or key combination was pressed, microprocessor 4 first determines from memory area 110 where in memory area 120 the information assigned to the key or key combination is stored. This location is stored as the memory address. The position where the memory address is stored in memory area 110 is calculated, for example, similar to the aforementioned method used in static management of memory 6, by storing the memory addresses equidistantly. This is possible because the memory addresses always have the same memory space requirement. The length of the data, stored in memory area 120, in contrast, is dynamic and corresponds to the actual need. Thus, there are no gaps in memory area 120, on the one hand, and on the other, the data can occupy almost as much memory space as desired (with individual differences). This is achieved by the indirect addressing via memory area 110.

The variables size of the data in memory area 120 is indicated in FIG. 5 by the memory cells of different size 101-106.

If the data in programmable memory 6 are to be changed or replaced, a memory map is generated in an external device and then transmitted to keyboard 1 via an interface such as keyboard interface 7 and stored in memory 6. The memory map is preferably generated with special software, not described in greater detail here, for example, on a PC with the PREH WinProgrammer software, whereby the data assigned to the keys and/or accessory devices are entered and the memory allocation table is automatically generated from this.

In the aforementioned exemplary embodiments, the dynamic memory management of the invention is described only in regard to the free programmability of the keys or key combinations of keyboard block 2. This type of dynamic memory management is understandably also possible in regard to other accessory devices of keyboard 1, such as the magnetic card reader 8, a chip card reader, or a key operated switch (not shown), etc.

It is apparent that the distribution of memory areas 110, 120, and 130 within memory 100 can occur in any other way desired.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for retrieving data assigned to keys and/or accessory devices of a freely programmable keyboard and stored in at least one programmable memory, wherein via memory addresses stored in a first area of the programmable memory, the memory locations containing the data are addressed in the second area of the programmable memory.

2. A method for the entry and/or change of data assigned to keys and/or accessory devices of a freely programmable keyboard and stored in at least one programmable memory, wherein the allocation of the programmable memory is set or changed in an external device and transmitted to the keyboard via an interface.

3. The method according to claim 2, wherein the assigned data are stored in the programmable memory in such a way that per key and/or accessory device only as much memory space is used as is absolutely necessary for the data to be stored and that the individual memory areas occupied by data are immediately adjacent to one another.

4. A programmable keyboard for carrying out the method according to claim 1, wherein the keyboard comprises: a keyboard block; a microprocessor; at least one programmable memory with data assigned to the keys and/or accessory devices of the freely programmable keyboard; a program memory; and an interface, wherein the occupation of the memory is transmitted to the keyboard via the interface.

5. The programmable keyboard according to claim 4, wherein the programmable memory and/or the program memory is integrated into the microprocessor.
